(19) United States
(12) Patent Application Publication
(10) Pub. No.: US 2010/0170250 A1
(43) Pub. Date: Jul. 8, 2010

(54) Fuel Plenum Vortex Breakers

(75) Inventors: Ghanshyam Singh, Bangalore Karnataka (IN); Praveen Babulal Jain, Bangalore Karnataka (IN)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/348,920

(22) Filed: Jan. 6, 2009

(51) Int. Cl. F02C 1/00

(52) U.S. Cl. 60/737; 60/748

(57) ABSTRACT

The present application provides a manifold for use with a gas turbine. The manifold may include a fuel passage and a swozzle vane in communication with the fuel passage. The swozzle vane may include a fuel plenum in communication with one or more fuel holes and a vortex breaker positioned about the fuel holes.

### TECHNICAL FIELD

The present application relates generally to gas turbine engines and more particularly relates to a vortex breaker for use in fuel plenums of combustor swozzle vanes.

### BACKGROUND OF THE INVENTION

Various types of combustors are known and used in gas turbine engines. In turn, these combustors generally use different types of fuel nozzles depending upon the type of fuel in use. For example, most natural gas fired systems operate using lean premixed flames. In these systems, fuel is mixed with air upstream of the reaction zone to create a premixed flame. One example is a “swozzle” (swirler+nozzle) in which the fuel ports are positioned about a number of extending vanes so as to inject the fuel into the air stream. Alternatively in systems using syngas or other types of fuels, diffusion nozzles may be used to inject the fuel and the air directly into the combustion chamber due to the generally higher reactivity of the fuel.

Current combustor designs, however, focus on fuel flexibility with respect to the use of natural gas and other types of fuels. As a result, operational issues may arise when switching from one type of fuel to another while using the same components. For. example, syngas may have a much higher volumetric flow rate as opposed to natural gas because of its higher reactivity. The design of the combustor thus should accommodate these varying characteristics.

There is thus a desire for improved combustor components in specific and improved turbine components in general that can provide greater fuel flexibility while maintaining system efficiency and limiting overall emissions. Specifically, such fuel flexible systems should accommodate natural gas and other types of fuels without extensive equipment changeovers.

### SUMMARY OF THE INVENTION

The present application thus provides a manifold for use with a gas turbine. The premix manifold may include a fuel passage and a swozzle vane in communication with the fuel passage. The swozzle vane may include a fuel plenum in communication with one or more fuel holes and a vortex breaker positioned about the fuel holes.

The present application further describes a method of modifying a recirculation vortex about one or more fuel holes within a fuel plenum of a manifold vane. The method may include the steps of flowing fuel through a fuel passage, turning the flow of fuel about ninety degrees into the fuel plenum so as to create the recirculation vortex therein, and positioning a vortex breaker about the fuel holes so as to modify the recirculation vortex.

The present application further describes a premix manifold for use with a gas turbine. The premix manifold may include a fuel passage and a swozzle vane in communication with the fuel passage. The swozzle vane may include a fuel plenum in communication with one or more fuel holes. The fuel plenum may be positioned at about a ninety degree turn from the fuel passage. The swozzle vane further may include a vortex breaker positioned about the fuel holes so as to reduce a recirculation vortex within the fuel plenum.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a turbine engine.

FIG. 2 is a side cross-sectional view of an existing combustor premix manifold.

FIG. 3 is a side cross-sectional view of a known fuel plenum as may be used with the premix manifold of FIG. 2 with the premixed fuel plenum shown in cross-section.

FIG. 4 is a side cross-sectional view of a fuel plenum with a vortex breaker as is described herein.

### DETAILED DESCRIPTION

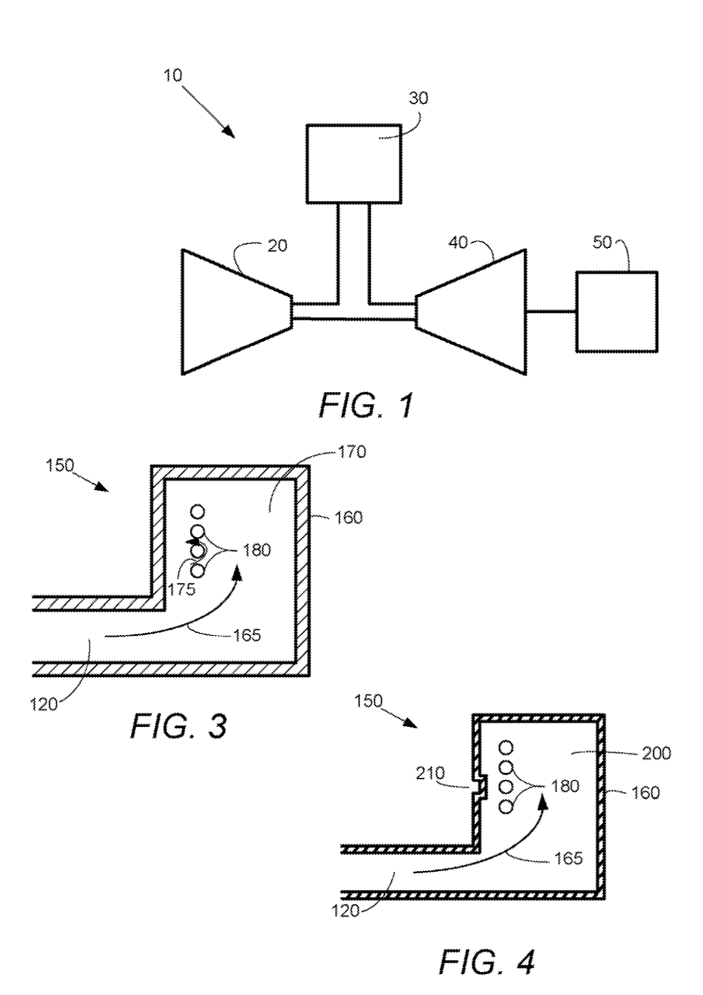

Referring now to the drawings, in which like numbers refer to like elements throughout the several views, FIG. 1 shows a schematic view of a gas turbine engine 10. As is known, the gas turbine engine 10 may include a compressor 20 to compress an incoming flow of air. The compressor 20 delivers the compressed flow of air to the combustor 30. The combustor 30 mixes the compressed flow of air with a flow of fuel and ignites the mixture. (Although only a single combustor 30 is shown, the gas turbine engine 10 may include any number of combustors 30.) The hot combustion gases are in turn delivered to a turbine 40. The turbine 40 drives the compressor 20 and an external load 50 such as an electrical generator and the like. The gas turbine engine 10 may use other configurations and components herein.

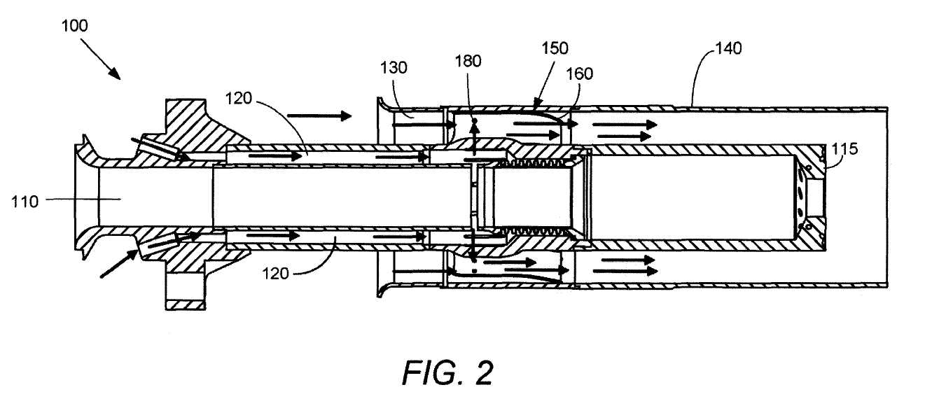

FIG. 2 shows a premix manifold 100 that may be used in the combustor 30. As is known, the premix manifold 100 may include a center diffusion fuel passage 110 that leads to a diffusion tip 115. The diffusion fuel passage 110 may be surrounded by a number of premixed fuel passages 120. The premixed fuel passages 120 in turn may be surrounded in part by an air passage 130. The air passage 130 may be enclosed via a burner tube 140. The premixed fuel passages 120 and the air passages 130 may be in communications with a swozzle 150. The swozzle 150 may have about (8) to about twelve (12) vanes 160 extending into the air passage 130. Any number of vanes 160 may be used. Each vane 160 may have one or more fuel plenums 170 therein and one or more fuel holes 180. Other types of manifold designs may be used herein. Any number of manifolds 100 may be used.

In use, the fuel is injected through the fuel holes 180 of the swozzle 150 and into the air passage 130. The primary purpose of the swozzle 150 is to inject the fuel into the air stream and introduce swirl so as to promote good mixing. The fuel mixes with the air in the burner tube 140 and then enters into a combustion zone or liner within the combustor 30.

Specifically, the premixed fuel enters the premix manifold 100, passes through the premixed fuel passages 120, and passes into the vanes 160 and the fuel plenums 170 of each swozzle 150. The fuel from the premixed fuel passages 120, however, takes a roughly ninety degree (90°) turn 165 when entering the fuel plenum 170 inside each vane 160.

The fuel thus may form a recirculation vortex 175 within the fuel plenum 170 when making this turn 165. Such a recirculation vortex 175 may swirl behind one or more of the fuel holes 180. For lower BTU gases (higher volumetric flow gasses as opposed to natural gas), the recirculation vortex 175 inside the fuel plenum 170 may result in a non-uniform fuel flux distribution through each fuel hole 180. Such a non-uniform fuel flux may provide uneven fuel jet penetration into the air passage 130. As a result, these recirculation vortexes 175 may lead to flame holding and higher emission due to poor fuel/air mixing. The strength of the recirculation vortexes 175 may increase with the volumetric flow rate.

Specifically, the dominant mechanism for flame holding or flashback may be the recirculation vortexes 175 behind the fuel holes 180. The non-uniform fuel flux may result in higher jet penetration through some of the fuel holes 180. These higher jets may form stronger recirculation vortexes 175 behind the jets and hence the chance for flame holding or flashback may be increased. The non-uniform fuel flow also may result in smaller jet penetration for other fuel holes 180. The fuel through the smaller jets may flow close to the vane wall and may not fully mix with the air stream. Such poor mixing thus may result in higher emissions.

FIG. 4 shows a fuel plenum 200 as is described herein. The fuel plenum 200 includes a vortex breaker 210 positioned therein. The vortex breaker 210 may be an aperture, a slot, an extruded block, or other type of obstruction through or in the fuel plenum 200 adjacent to one or more of the fuel holes 180. In this context, any suitably shaped, sized, and positioned aperture or obstruction that reduces or eliminates the strength of the vortex may serve as the vortex breaker 210. Specifically the vortex breaker 210 may be a passive flow control device that reduces or eliminates an excessive pressure drop and the associated recirculation.

Any number of the vortex breakers 210 may be used. The size, shape, number, and location of the vortex breakers 210 may depend upon the nature and speed of the fuel flowing therein, although it appears that the best location for the vortex breaker 210 may be nearer to the center of the recirculation vortex. The vortex breaker 210 may be used at any place inside the passage where fuel is being injected into the air for premixing. Although the vortex breaker 210 shown here is used in a swozzle fuel plenum 200, it also may be used in any other plenum where an excessive pressure drop needs to be controlled. The vortex breaker 210 may be used with any fluid that may create recirculations in a flow path.

As compared to the fuel plenums 170 without the vortex breakers 210, the fuel plenums 200 with the vortex breaker 210 have a more even pressure drop across each of the fuel holes 180. This even pressure loss thus may result in a more uniform fuel flux. Moreover, the overall pressure drop may be reduced by weakening the recirculation vortex 175. The vortex breakers 210 or similar designs also may be used within fuel pegs.

The vortex breaker 210 thus helps to reduce or eliminate the recirculation vortex 175 and hence provides a more uniform fuel flux through each of the fuel holes 180. The more uniform fuel flux thus may increase flame holding margins and reduce emissions by improving overall mixing. Improved flame holding also may increase the life of the premix manifold 100 as a whole and help to reduce overall maintenance costs. Likewise, improved flame holding may reduce outage time due to premixer failure. As above, improved flame holding largely increases fuel flexibility of the turbine 10 as a whole so as to accommodate different kinds of fuels without adverse effect on operability. The vortex breaker 210 helps in reducing the recirculation vortex inside the fuel plenum and thereby improves the operability with different fuels. Eliminating the recirculating vortex also should help in eliminating or reducing flow and combustion induced instabilities.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A manifold for use with a gas turbine, comprising:
a fuel passage; and
a swozzle vane in communication with the fuel passage;
the swozzle vane comprising a fuel plenum in communication with one or more fuel holes; and
the swozzle vane comprising a vortex breaker positioned about the one or more fuel holes.

2. The manifold of claim 1, further comprising an air passage about the swozzle vane.

3. The manifold of claim 1, wherein the fuel plenum is positioned at about a ninety degree turn from the fuel passage.

4. The manifold of claim 1, wherein the vortex breaker reduces or eliminates a recirculation vortex within the fuel plenum.

5. The manifold of claim 1, wherein the vortex breaker comprises an aperture or obstruction within the fuel plenum.

6. The manifold of claim 1, wherein the vortex breaker comprises a plurality of vortex breakers.

7. The manifold of claim 1, wherein the vortex breaker is positioned about a middle portion of the fuel plenum.

8. A method of modifying a recirculation vortex about one or more fuel holes within a fuel plenum of a manifold vane, comprising:
flowing fuel through a fuel passage;
turning the flow of fuel about ninety degrees into the fuel plenum so as to create the recirculation vortex therein; and
positioning a vortex breaker about the one or more fuel holes so as to modify the recirculation vortex.

9. The method of claim 8, further comprising flowing air about the manifold vane.

10. The method of claim 8, wherein a first flow rate of the flow of fuel provides a first recirculation vortex comprising a first strength.

11. The method of claim 10, wherein a second flow rate of the flow of fuel provides a second recirculation vortex comprising a second strength.

12. The method of claim 8, wherein the step of positioning the vortex breaker about the one or more fuel holes provides a uniform flow of fuel through the one or more fuel holes.

13. The method of claim 8, wherein the step of positioning the vortex breaker about the one or more fuel holes provides a uniform pressure drop across the one or more fuel holes.

14. The method of claim 8, further comprising positioning a plurality of vortex breakers about the one or more fuel holes.

15. A premix manifold for use with a gas turbine, comprising:
a fuel passage; and
a swozzle vane in communication with the fuel passage,
the swozzle vane comprising a fuel plenum in communication with one or more fuel holes;
wherein the fuel plenum comprises about a ninety degree turn from the fuel passage; and
wherein the swozzle vane comprises a vortex breaker positioned about the one or more fuel holes so as to reduce a recirculation vortex within the fuel plenum.

16. The premix manifold of claim 15, further comprising an air passage about the swozzle vane.

17. The premix manifold of claim 15, wherein the vortex breaker comprises an aperture or obstruction within the fuel plenum.

18. The premix manifold of claim 15, wherein the vortex breaker comprises a plurality of vortex breakers.

19. The premix manifold of claim 15, wherein the vortex breaker is positioned about a middle portion of the fuel plenum.
